(19) United States
(12) Patent Application Publication
(10) Pub. No.: US 2013/0125001 A1
(43) Pub. Date: May 16, 2013

(54) Digital Photo Album

(71) Applicant: Lenore Watson, Brooklyn, NY (US)

(72) Inventor: Lenore Watson, Brooklyn, NY (US)

(21) Appl. No.: 13/297,473

(22) Filed: Nov. 16, 2011

(51) Int. Cl. G06F 3/00; G06F 3/048

(52) U.S. Cl. 715/730; 715/781

(57) ABSTRACT

A digital photo book for storage and display of digital photos comprising: a photo array, where the photo array includes a means for displaying a plurality of digital photo images; an interactive means, where the interactive means controls the display of the digital photo images; a cover, where the cover covers the photo array and interactive means; a view window positioned on the cover, where the view window displays one of the digital photo images; memory, where the memory stores the digital photos available for display in the photo array; a processor, where the processor processes the functions related to the display of the digital photos; and a power source, where the power source provides power to any components of the digital photo book.

### BACKGROUND OF THE INVENTION

1. Field of Invention

The present invention relates to a digital photo album for the digital storage of a multiple selection of photos.

2. Description of Related Art

As is well known the photographs have been used to depict images for years since the early days of photography. The traditional photograph was originally a snapshot that was burned onto a film negative through exposure of the image in front of a shutter. After exposure the negative is developed as a photograph for display, publication or storage. The traditional photography therefore involves a two-prong process of development and then printing on a suitable paper or mat. Over recent years photography has evolved immensely through the use of digital photography. Now the more modern photograph is usually a digital image that's stored onto a digital storage device, such as a memory card or hard drive of a computer. The use of digital photos, the capability of photography and the volume of photographs has grown immensely through the use of digital photography. Although some individuals still desire a physical print of the particular photographs many individuals store digital photographs on the memory of their computers or a storage card that may be associated with a digital camera.

Consequently, various devices have been developed to store digital photos for display such as digital photo albums that store the photographs in digital form for display on a video screen. Digital photo albums usually include a hard drive and a processor that enables the user to manipulate the size and display options associated with the stored digital photos. Since the digital photograph is well established with the consumer and professional photographers multiple means of digital photograph storage and display are consequently necessary.

### SUMMARY OF THE INVENTION

The present invention relates to a digital photo book for storage and display of digital photos comprising: a photo array, where the photo array includes a means for displaying a plurality of digital photo images; an interactive means, where the interactive means controls the display of the digital photo images; a cover, where the cover covers the photo array and interactive means; a view window positioned on the cover, where the view window displays one of the digital photo images; memory, where the memory stores the digital photos available for display in the photo array; a processor, where the processor processes the functions related to the display of the digital photos; and a power source, where the power source provides power to any components of the digital photo book. The interactive means may include a keyboard for controlling the display of photos. In one particular embodiment, the plurality of digital photo images are thumbprint size photos and may be shown in a slide show format in the view window.

### BRIEF DESCRIPTION OF DRAWINGS

FIG. 1 depicts an electronic digital photo storage book in accordance with the present invention.

FIG. 2 depicts a cover for the digital photo storage book in accordance with the present invention.

### DETAILED DESCRIPTION

The present invention relates to an electronic digital photo book for digital photograph storage. The present invention includes a photo array that displays multiple thumb print size images of photos stored in the memory of the digital photo book. Photos may be displayed on the photo array and then viewed in a viewing window that is supplied as a cover to the digital photo book. The user may view multiple photos at a time by removing the cover from the digital photo book and a single photo may be displayed in a viewing window of the cover of the digital photo book. A keyboard is provided to help navigate and select the viewing subject matter of the photo array and the subject matter of the viewing window of the cover for the digital photo book.

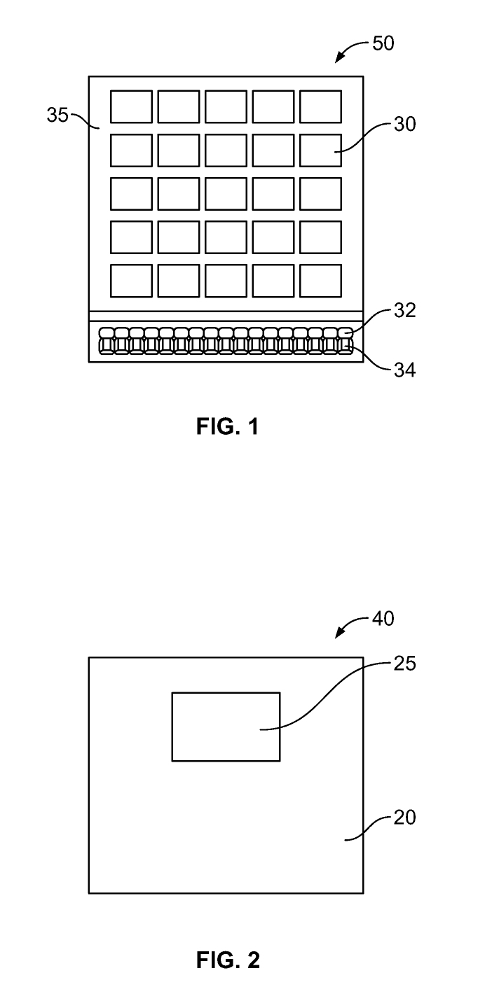

In reference to FIG. 1, a view of an electronic digital photo book 50 according to the present invention is depicted. The digital photo book 50 according to the present invention includes a photo array 35 displayed over the surface of the digital photo book 50. This photo array 35 depicts multiple thumb print images of digital photos stored in the memory of the digital photo book 50. A thumb print image 30 is shown in the photo array 35. Each thumb print image 30 may change accordingly through the use of the input device or keyboard 34 provided with the digital photo book 50. A user uses the keyboard 34 to change the images shown on the photo array 35 and may input descriptive data, i.e. location, time and/or subject, related to each digital photo stored in the memory of the digital photo book 50.

A cover 40 is provided for the digital photo album 50 as shown in FIG. 2. The cover 40 is placed over the photo array 35 and a particular photograph is selected for display in the photo view window 25. The photo view window 25 depicts a single photo stored in the memory of the digital photo book 50. This photo view window 25 includes an outer border or solid surface 20 as shown in FIG. 2. The cover 40 is placed over the photo array therefore a single photo is shown as desired in the view window 25. Through the use of the keyboard 34, a user may make a selection as to which particular photo is shown in the view window 25. Further as an alternative option, a sequence of photographs may be shown in the view window 25 in a slide show fashion, where multiple photographs are shown from the photo array 35 in the view window 25. Again the viewer controls which photograph is displayed in the view window 25. Further the user may control which multiple photographs are shown in a slide show fashion through the view window 25.

Although not shown, the digital photo book 50 includes a processor and memory stored internally. Further various customary input/output devices may be connected to the digital photo book such as a USB cord or attachment for the transfer of photos from a digital camera or other storage devices. The digital photo book 50 according to present invention allows the user to control the individual display shown in the view window 25 and also allows the user to have a photo array of multiple thumb size images of the digital photos stored in the digital photo book. Limitations on the number, size and volume of photos stored in the digital photo book would coincide with the processor and memory available stored on the digital photo book. The instant invention has been shown and described in what it considers to be the most practical and preferred embodiments. It is recognized, however, that departures may be made there from within the scope of the invention and that obvious modifications will occur to a person skilled in the art.

What is claimed is:

1. A digital photo book for storage and display of digital photos comprising
a. a photo array, where the photo array includes a means for displaying a plurality of digital photo images;
b. an interactive means, where the interactive means controls the display of the digital photo images;
c. a cover, where the cover covers the photo array and interactive means;
d. a view window positioned on the cover, where the view window displays one of the digital photo images;
e. memory, where the memory stores the digital photos available for display in the photo array;
f. a processor, where the processor processes the functions related to the display of the digital photos; and
g. a power source, where the power source provides power to any components of the digital photo book.

2. The digital photo book according to claim 1, where the interactive means includes a keyboard.

3. The digital photo book according to claim 1, where plurality of digital photo images are thumbprint size photos.

4. The digital photo book according to claim 1, where the photo images are shown in a slide show format in the view window.
